(19) United States
(12) Patent Application Publication
(10) Pub. No.: US 2006/0261318 A1
(43) Pub. Date: Nov. 23, 2006

(54) Light control film

(75) Inventors: Junji Morimoto, Osaka (JP); Sang Jin Lee, Niihama-shi (JP); Han Young Choi, Jung-gu (KR)

Correspondence Address: BIRCH STEWART KOLASCH & BIRCH, PO BOX 747, FALLS CHURCH, VA, 22040-0747, US

(73) Assignee: Sumitomo Chemical Company, Limited

(21) Appl. No.: 11/433,429

(22) Filed: May 15, 2006

(30) Foreign Application Priority Data
May 17, 2005 (JP) 2005-143636
Dec. 28, 2005 (JP) 2005-377033

(51) Int. Cl. F21V 9/00; G02C 7/10; B32B 17/10

(52) U.S. Cl. 252/582; 428/409

(57) ABSTRACT

A light control film obtained by irradiating a composition in the form of sheet comprising at least one compound having a plurality of aromatic rings and one polymerizable carbon-carbon double bond in the molecule with ultraviolet ray and hardening the composition.

### TECHNICAL FIELD OF THE INVENTION

The present invention relates to a light control film.

### BACKGROUND OF THE INVENTION

Light control films selectively scattering only incident light in a certain angle region to give high haze value (opacity) and allowing permeation of incident light in other angle regions to give low haze value (transparency) are used as optical films such as a viewing angle control film pasted to a windowpane for protecting privacy, a cash dispenser touch panel and the like, a viewing angle enlarging film of a flat panel display, and the like.

As such a light control film, there is known, for example, a light control film obtained by irradiating a composition in the form of sheet containing 2-hydroxy-3-phenoxypropyl acrylate and polyether urethane acrylate with ultraviolet ray, and it is disclosed that this light control film has a haze value in an opaque angle region of 79% and a haze value in a transparent angle region of 5% or less (Japanese Patent Application Laid-Open (JP-A) No. 6-11606 (Example 5)).

Recently, for the purpose of protecting privacy, there is required development of a light control film showing high visibility, namely, sufficiently low haze value in a transparent angle region and showing invisibility, namely, sufficiently high haze value in an opaque angle region, that is, a light control film excellent in contrast.

The present inventors have investigated to find a light control film excellent in contrast and resultantly found that a light control film obtained by hardening a composition in the form of sheet containing a certain kind of compound has excellent contrast.

### DISCLOSURE OF THE INVENTION

The object of the present invention is to provide a light control film showing a sufficiently low haze value of 5% or less in a transparent angle region and showing higher haze value in an opaque angle region.

That is, the present invention provides the following [1]-[7].

[1] A light control film obtained by irradiating a composition in the form of sheet comprising at least one compound having a plurality of aromatic rings and one polymerizable carbon-carbon double bond in the molecule with ultraviolet ray and hardening the composition.

[2] The light control film according to [1], wherein at least one compound having a plurality of aromatic rings and one polymerizable carbon-carbon double bond in the molecule is a compound containing no aromatic hydroxyl group and the content of the compound based on 100 parts by weight of the composition in the form of sheet is 10 to 90 parts by weight.

[3] The light control film according to [2], wherein the compound containing no aromatic hydroxyl group is at least one compound selected from the group consisting of 2-phenylphenyl acrylate, p-cumylphenoxy ethyl acrylate, 4-benzylphenyl acrylate and diphenyl methyl acrylate.

[4] The light control film according to [1], wherein at least one compound having a plurality of aromatic rings and one polymerizable carbon-carbon double bond in the molecule is a compound containing an aromatic hydroxyl group and the content of the compound based on 100 parts by weight of the composition in the form of sheet is 0.1 to 30 parts by weight.

[5] The light control film according to [4], wherein the compound containing an aromatic hydroxyl group is at least one compound selected from the group consisting of 2-t-butyl-6-(3′-t-butyl-5′-methyl-2′-hydroxybenzyl)-4-methylphenyl acrylate and 2-[1-(2-hydroxy-3,5-di-t-pentylphenyl)ethyl]-4,6-di-t-pentylphenyl acrylate.

[6] The light control film according to [1], wherein the compound contained in the composition in the form of sheet includes at least two compounds of which homopolymers show a difference in refractive index of 0.01 or more.

[7] The light control film according to [1], wherein the composition in the form of sheet is a composition comprising an oligomer having a refractive index of less than 1.51 as the compound having a polymerizable carbon-carbon double bond.

### BRIEF EXPLANATION OF DRAWINGS

FIG. 1(i) shows a side elevational view of an ultraviolet ray hardening apparatus and FIG. 1(ii) shows a perspective view of an ultraviolet ray hardening apparatus.

FIG. 2 is a schematic view showing a method of measuring angle dependency of haze value.

FIG. 3 shows haze value curves of Example 1 and Comparative Examples 1 and 2.

FIG. 4 shows haze value curves of Examples 2 and 3.

FIG. 5 shows haze value curves of Examples 4 to 6.

### DESCRIPTION Of MARKS

1 laminate of resin composition in the form of sheet and glass base material
2 conveyer
3 shading plate
4 slit provided on shading plate
5 light source lamp in the form of rod (high pressure mercury lamp)
6 specimen measuring haze value (light control film)

### MODES FOR CARRYING OUT THE INVENTION

The present invention will be illustrated in detail below.

The compound contained in the composition in the form of sheet used in the present invention is a compound having a plurality of aromatic rings and one polymerizable carbon-carbon double bond in the molecule (hereinafter, referred to as compound A in some cases).

The aromatic ring contained in compound A is a hydrocarbon ring having an aromatic property, and a carbon atom may be substituted by a nitrogen atom, oxygen atom, sulfur atom or the like providing it has an aromatic property. To the aromatic ring, an alkyl group such as a methyl group, ethyl group, n-propyl group, i-propyl group, n-butyl group, t-butyl group and the like, an alkoxy group such as a methoxy group, ethoxy group and the like, or a halogen group such as a fluoro group, chloro group, bromo group and the like may be bonded.

The aromatic ring may be a condensed ring such as a naphthalene ring, anthracene ring and the like. In the present invention, the condensed ring having an aromatic property means a plurality of aromatic rings.

Examples of the aromatic ring include a benzene ring, methylbenzene ring, dimethylbenzene ring, chlorobenzene ring, pentafluorobenzene ring, biphenyl ring, naphthalene ring, anthracene ring, phenanthrene ring, pyridine ring, pyrrole ring and the like. Of them, a plurality of benzene rings are preferable as a plurality of aromatic rings contained in a molecule of the compound A.

The number of aromatic rings contained in a molecule of the compound A is usually 2 to 6, preferably 2 to 4.

Mutual bonds of a plurality of aromatic rings other than a condensed ring include bonds via a connecting group, in addition to a single bond. Examples of the connecting group include alkylidene groups having about 2 to 6 carbon atoms such as an ethylidene group, propylidene group, isopropylidene group and the like; alkylene groups having about 1 to 6 carbon atoms such as a methylene group, ethylene group, propylene group and the like; alkylene oxide groups such as an ethylene oxide group, propylene oxide group and the like; ether group, carboxy group, glycidyl ether group, and the like. Different two connecting groups may be combined.

Among them, bonds via an alkylidene group or alkylene group, or a single bond, are preferable.

The polymerizable carbon-carbon double bond contained in the compound A is a bond capable of generating a new carbon-carbon bond by mutual addition polymerization of this double bond, and specifically, includes a vinyl group, allyl group, styryl group, acryloyl group, methacryloyl group, acrylamide group, trans-1-oxo-2-butenoxy group, cinnamoyl group, butadiene structure, cycloolefin structures such as a cyclopentene ring structure and the like. Of them, compounds having an acryloyl group or methacryloyl group are preferable because of excellent photosensitivity, and compounds having an acryloyl group are more preferable.

The polymerizable carbon-carbon double bond and aromatic ring may be bonded directly or bonded via a connecting group exemplified above.

The compound A may be a compound containing a hydroxyl group (hereinafter, referred to as compound A1 in some cases) or a compound containing no hydroxyl group (hereinafter, referred to as compound A2 in some cases).

In the composition in the form of sheet used in the present invention, a compound A1 and a compound A2 may be used in admixture. As the compound A1, different two compounds A1 may be used, and as the compound A2, different two compounds A2 may be used.

To a carbon atom at α-position of a polymerizable carbon-carbon double bond in a compound A1, a secondary or tertiary alkyl group such as an i-propyl group, t-butyl group, neopentyl group and the like, or a bulky group such as a bromine atom and the like, may be bonded.

Specific examples of the compound A1 include 2-t-butyl-6-(3′-t-butyl-5′-methyl-2′-hydroxybenzyl)-4-methylphenyl acrylate, 2-[1-(2-hydroxy-3,5-di-t-pentylphenyl)ethyl]-4,6-di-t-pentylphenyl acrylate, 2-[1-(2-hydroxy-3,5-di-t-pentylphenyl)ethyl]-4,6-di-t-pentylphenyl methacrylate, 2-(2-hydroxy-3,5-di-t-pentylbenzyl)-4,6-di-t-pentylphenyl acrylate, 2,4-di-t-butyl-6-[1-(3,5-di-t-butyl-2-hydroxyphenyl)ethyl]phenyl acrylate, 2,4-di-t-butyl-6-(3,5-di-t-butyl-2-hydroxybenzyl)phenyl acrylate, 2,4-di-t-butyl-6-[1-(3,5-di-t-butyl-2-hydroxyphenyl)ethyl]phenyl methacrylate, 2-t-butyl-6-[1-(3-t-butyl-2-hydroxy-5-methylphenyl)ethyl]-4-methylphenyl acrylate, 2-t-butyl-6-(3-t-butyl-2-hydroxy-5-methylbenzyl)-4-methylphenyl methacrylate, 2-t-butyl-6-[1-(3-t-butyl-2-hydroxy-5-methylphenyl)propyl]-4-methylphenyl acrylate, 2-t-butyl-6-(3-t-butyl-5-ethyl-2-hydroxybenzyl)-4-ethylphenyl acrylate, 2-t-butyl-6-[1-(3-t-butyl-2-hydroxy-5-propylphenyl)ethyl]-4-propylphenyl acrylate, 2-t-butyl-6-[1-(3-t-butyl-2-hydroxy-5-isopropylphenyl) ethyl]-4-isopropylphenyl acrylate, and the like.

As the compound A1, 2-t-butyl-6-(3′-t-butyl-5′-methyl-2′-hydroxybenzyl)-4-methylphenyl acrylate and 2-[1-(2-hydroxy-3,5-di-t-pentylphenyl)ethyl]-4,6-di-t-pentylphenyl acrylate are preferably used.

Since the compound A1 has a tendency of low addition polymerizability, the compound is used in an amount of usually 0.1 to 30 parts by weight, preferably 1 to 20 parts by weight based on 100 parts by weight of a composition in the form of sheet for sufficiently hardening the composition in the form of sheet.

The composition in the form of sheet of the present invention preferably contains further two or more compounds having a polymerizable carbon-carbon double bond containing a compound A2 described later, differing from the compound A1.

The molecular weight of two or more compounds different from the compound A1 contained in a composition in the form of sheet containing the compound A1 is usually less than 1000, and the refractive index of a homopolymer of each compound is usually 1.51 or more. The content of two or more compounds different from the compound A1 is usually about 10 to 90 parts by weight, preferably about 30 to 70 parts by weight based on 100 parts by weight of the composition in the form of sheet.

Since the compound A2 is excellent in addition polymerizability, the compound is used in an amount of usually 10 to 90 parts by weight, preferably 30 to 70 parts by weight based on 100 parts by weight of a composition in the form of sheet.

A homopolymer of the compound A2 has a refractive index of usually 1.51 or more, and the compound A2 has a molecular weight of usually less than 1000.

Specific examples of the compound A2 include diphenyl methyl acrylate, 4-phenyl phenyl acrylate, 4-(2,4,6-tribromophenyl)-2,6-dibromophenyl acrylate, 2-phenyl phenyl acrylate, 4-phenylphenoxy ethyl acrylate, p-cumylphenyl acrylate, p-cumylphenoxy ethyl acrylate, 2-[p-cumylphenoxy-2-methyl]ethyl acrylate, 4-[1-(4-acetoxyphenyl)-1-methylethyl]phenyl acrylate, 4-[1-(4-methoxyphenyl)-1-methylethyl]phenyl acrylate, 4-[1-(4-isopropoxyphenyl)-1-methylethyl]phenyl acrylate, 4-[1-(4-benzoxyphenyl)-1-methylethyl]phenyl acrylate, 4-[1-(4-benzyloxyphenyl)-1-methylethyl]phenyl acrylate, 4-[1-(4-acetoxyphenyl)-1-methylethyl]phenoxyethyl acrylate, 4-[1-(4-methoxyphenyl)-1-methylethyl]phenoxyethyl acrylate, 4-[1-(4-isopropoxyphenyl)-1-methylethyl]phenoxyethyl acrylate, 4-[1-(4-benzoxyphenyl)-1-methylethyl]phenoxyethyl acrylate, 4-[1-(4-benzyloxyphenyl)-1-methylethyl]phenoxyethyl acrylate, 4-benzylphenyl acrylate, 1-naphthyl acrylate, 2-naphthyl acrylate, 1-naphthoxy ethyl acrylate, 4-(2-furyl)phenyl acrylate, 4-(3-thiophenyl)phenyl acrylate, methacrylate monomers corresponding to these acrylates, and the like.

As the compound A2, p-cumylphenyl acrylate, 2-phenyl phenyl acrylate, 4-benzylphenyl acrylate and diphenyl methyl acrylate are preferably used.

The composition in the form of sheet used in the present invention may contain a compound having a polymerizable carbon-carbon double bond different from the compound A. Specifically exemplified are compounds having no aromatic ring in the molecule or having one aromatic ring in the molecule, and having one or more polymerizable carbon-carbon double bonds in the molecule (hereinafter, referred to as compound B in some cases).

Examples of the compound B include compounds having no aromatic ring in the molecule and having one polymerizable carbon-carbon double bond in the molecule such as tetrahydrofurfuryl acrylate, ethyl carbitol acrylate, dicyclopentenyoxy ethyl acrylate, ω-hydroxyhexanoyloxy ethyl acrylate, acryloyloxy ethyl succinate, acryloyloxy ethyl phthalate, isobornyl acrylate, 2-ethylhexyl acrylate, lauryl acrylate, 2,2,3,3-tetrafluoropropyl acrylate and methacrylates corresponding to these acrylates, and the like; compounds having one aromatic ring in the molecule and having one polymerizable carbon-carbon double bond in the molecule such as phenylcarbitol acrylate, nonylphenoxy ethyl acrylate, 2-hydroxy-3-phenoxypropyl acrylate, tribromophenoxy ethyl acrylate, N-vinylpyrrolidone, N-acryloylmorpholine and the like;

compounds having no aromatic ring in the molecule and having a plurality of polymerizable carbon-carbon double bonds in the molecule such as triethylene glycol diacrylate, polyethylene glycol diacrylate, neopentyl glycol diacrylate, 1,6-hexanediol diacrylate, hydrogenated dicyclopentadienyl diacrylate, trimethylolpropane triacrylate, pentaerythritol hexaacrylate, trisacryloxy isocyanurate, poly-functional epoxy acrylate, poly-functional urethane acrylate, methacrylates corresponding to these acrylates, diethylene glycol bisallyl carbonate, butadiene and the like; compounds having an aromatic ring in the molecule and having a plurality of polymerizable carbon-carbon double bonds in the molecule such as ethylene oxide-modified bisphenol A diacrylate, divinylbenzene, triallyl isocyanurate, and the like.

The content of the compound B based on 100 parts by weight of the composition in the form of sheet used in the present invention is usually about 10 to 90 parts by weight, preferably about 30 to 70 parts by weight.

By using the compound B, regulation of compatibility and regulation of viscosity of the composition in the form of sheet can be carried out easily.

The molecular weight of the compound B is usually less than 1000.

The composition in the form of sheet used in the present invention may contain an oligomer of which homopolymer has an refractive index of less than 1.51, preferably 1.50 or less, as the compound having a polymerizable carbon-carbon double bond different from the compound A and the compound B.

Specific examples of the oligomer include poly-functional acrylate oligomers such as polyester acrylate, polyol polyacrylate, modified polyol polyacrylate, polyacrylate of isocyanuric acid skeleton, melamine acrylate, polyacrylate of hydantoin skeleton, polybutadiene acrylate, epoxy acrylate, urethane acrylate oligomer and the like, and methacrylate oligomers corresponding these acrylates, and the like.

As the urethane acrylate oligomer, for example, those produced by an addition reaction of polyisocyanate, polyol and 2-hydroxyalkyl(meth)acrylate are exemplified. Here, the polyisocyanate includes toluene diisocyanate, isophorone diisocyanate, trimethylhexamethylene diisocyanate, hexamethylene diisocyanate, and the like.

Examples of the polyol include polyether polyols such as polyethylene glycol, polypropylene glycol polytetramethylene glycol and the like.

The molecular weight of the oligomer is usually 1000 or more.

The content of the oligomer based on 100 parts by weight of the composition in the form of sheet used in the present invention is usually about 10 to 90 parts by weight, preferably about 30 to 70 parts by weight.

By using the oligomer in an amount in the above-mentioned range, there is a preferable tendency that flexibility and friction resistance are improved.

The composition in the form of sheet contains as an essential component a compound A as the compound having a polymerizable carbon-carbon double bond, and usually, further contains a plurality of compounds such as a compound having a plurality of polymerizable carbon-carbon double bonds such as a compound B and/or oligomer, and the like, and the refractive indices of homopolymers of the compounds to be contained in the composition in the form of sheet are usually different mutually, and when a difference of these refractive indices is larger, the haze value of the resulting light control film is larger. It is preferable that homopolymers of at least two compounds among the compounds having a polymerizable carbon-carbon double bond show a difference in refractive index of at least 0.01, more preferably 0.02. When three or more compounds are used, it is preferable that a difference in refractive index between any two of the homopolymers satisfies the above-mentioned condition.

The mixing ratio of two compounds showing a difference in refractive index of at least 0.01 is preferably in a range of 10:90 to 90:10 by weight. It is preferable that compatibility of these compounds is lower.

The composition in the form of sheet may contain, for example, polymers such as polystyrene, polymethyl methacrylate, polyethylene oxide, polyvinylpyrrolidone, polyvinyl alcohol, nylon and the like, organic chemicals such as toluene, n-hexane, cyclohexane, methyl alcohol, ethyl alcohol, acetone, methyl ethyl ketone, tetrahydrofuran, ethyl acetate, dimethylformamide, dimethylacetamide, acetonitrile and the like, plastic additives such as organic halogen compounds organic silicon compounds, plasticizers, stabilizers and the like, providing photocontrollability is not prevented.

The composition in the form of sheet can be obtained by sheet formation by a method of applying such monomer compounds and the like on a base plate such as a glass plate, polyethylene terephthalate plate and the like, a method of filling such monomer compounds and the like in a cell, or other methods.

The composition in the form of sheet usually has a thickness of about 25 μm to 1000 μm, a width of about 5 cm to 300 cm, and a length of about 5 cm to several hundreds m.

Compositions in the form of sheet deprived of oxygen such as a composition in the form of sheet obtained by filling in a cell do not necessarily require a photoinitiator, however, as compositions in the form of sheet obtained by general methods such as a method of applying on a base plate, and the like, a composition in the form of sheet containing a photoinitiator previously mixed is used for improving degree of hardening.

Examples of the photoinitiator include benzophenone, benzil, Michler's ketone, 2-chlorothioxanetone, 2,4-diethylthioxanetone, benzoin methyl ether, benzoin ethyl ether, diethoxyacetophenone, benzyl dimethyl ketal, 2-hydroxy-2-methylpropiophenone, 1-hydroxycyclohexyl phenyl ketone and the like.

The use amount of the photoinitiator is usually about 0.01 to 5 parts by weight, preferably about 0.1 to 3 parts by weight, based on 100 parts by weight of the composition in the form of sheet.

The composition in the form of sheet can be made into a film by a method of applying on a base plate, a method of filling in a cell, or the like and irradiated with ultraviolet ray to obtain a light control film of the present invention.

As the method for irradiation with ultraviolet ray, there is, for example, a method in which light from a light source in the form of rod is allowed to irradiate a surface of a composition in the form of sheet via a slit of a shading plate as a beam vertical to the surface of a composition in the form of sheet. By irradiation, the surface of a composition in the form of sheet is hardened gradually.

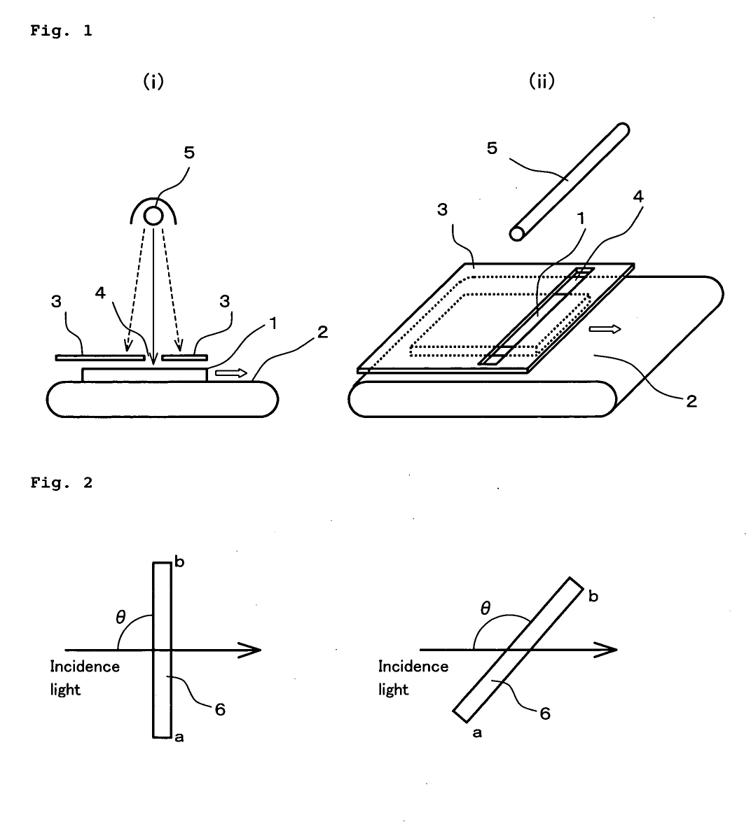

Specifically, light of a light source 5 in the form of rod is irradiated as a beam along vertical direction via a slit 4 of a shading plate 3, as in an ultraviolet hardening apparatus in FIG. 1, and a composition 1 in the form of sheet applied on a glass plate is placed on a conveyer 2, and conveyed usually at a rate of 0.01 to 10 m/min, preferably about 0.1 to 5 m/min while gradually hardening this.

As the beam to be irradiated in producing a light control film, for example, beams containing ultraviolet ray are mentioned, and preferably, ultraviolet rays having wavelengths of 400 nm or less are mentioned. When the beam is ultraviolet ray having a wavelength of 400 nm or less, there is a preferable tendency that the width of an opaque angle region increases.

As the ultraviolet ray having a wavelength of 400 nm or less, ultraviolet ray obtained by permeation of a beam through an interference filter other than interference filters showing a transmittance at a wavelength of 313 nm of 5 to 60%, placed between a composition 1 in the form of sheet applied on a glass plate and a shading plate 3, is used.

Used as the light source of ultraviolet ray are light sources in the form of rod such as a mercury lamp, metal halide lamp and the like, a lot of point light sources sequentially arranged in linear form, linear light sources such as a light source of scanning light from laser ray or the like using a revolution mirror and a concave mirror (irradiation from different lot of angles to one irradiated position), and the like. Of them, the light source in the form of rod is preferable because of easy handling.

The composition in the form of sheet shows anisotropy for the major axis direction and the minor axis direction, and scatters light at a specific angle only when the composition in the form of sheet is shifted along the minor axis direction of the light source. Namely, in the composition in the form of sheet, regions of difference refractive indices form layers of fine structure periodically present under condition of orientation parallel to the major axis direction of the light source. It is believed that, by this, incidence light on a light control film of the present invention from a specific angle is scattered in a region of different refractive index.

The maximum haze value imparted by the light control film of the present invention (maximum degree of opacity against linear permeation) is preferably 80% or more, and it is preferable that the haze value (degree of transparency) is 5% or less in an angle region for permeation of incidence light since then contrast is larger.

The present invention can provide a light control film excellent in contrast between a transparent angle region and an opaque angle region, showing sufficiently low haze value (transparency) in a transparent angle region and showing higher haze value in an opaque angle region.

### EXAMPLES

The present invention will be illustrated further specifically below based on examples, but it is needless to say that the present invention is not limited to these examples.

The whole beam transmittance and the diffusion transmittance of a light control film were measured using an integrating sphere mode beam transmittance measuring apparatus (Haze Guard Plus 4725 manufactured by Gardner) at a distance of 4 cm between the center of the light control film and an integrating sphere, and the haze value is measured by the following formula.
Haze value (%)=(diffusion transmittance (%)/whole beam transmittance (%))×100
Diffusion transmittance=whole beam transmittance−parallel beam transmittance

The angle dependency of haze value in a light control film is measured as described below. That is, as shown in FIG. 2, the angle θ of incidence light into a specimen 6 of the light control film is changed between 0 to 180°, and the above-mentioned haze value is measured for every angle. Here, the angle θ is a value when a direction parallel to a surface of the specimen 6 is 0° and the normal line direction of the specimen 6 is 90°, and rotation of the specimen 6 is carried out toward a direction at which the angle dependency of haze value is maximum. a and b in the FIG. 2 are marks imparted to teach the corresponding part of the specimen 6 between the left figure (light is directed to specimen 6 from vertical direction: θ=90°) and the right figure (light is directed to specimen 6 from inclined direction).

### Example 1

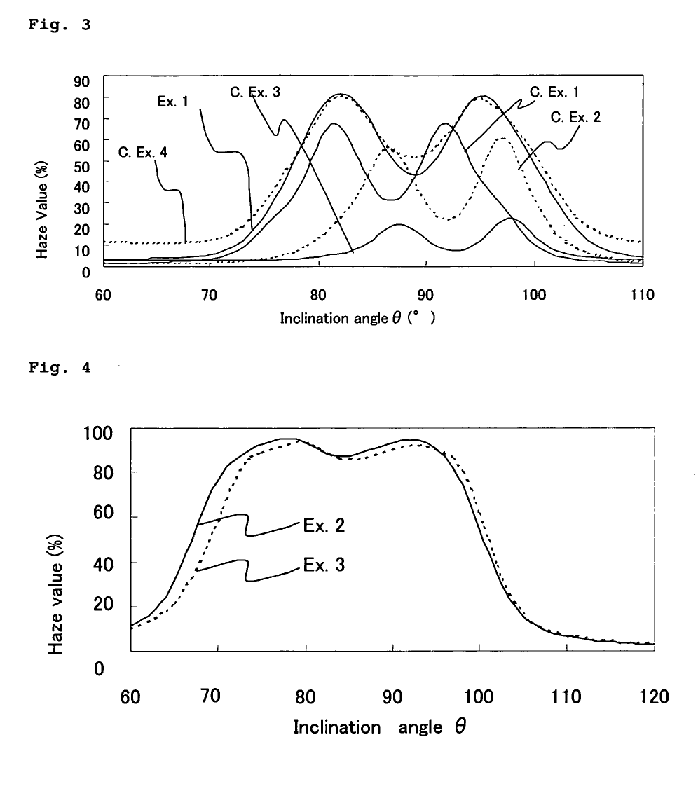

On a glass plate was applied a resin composition at a thickness of 220 μm obtained by mixing 30 parts by weight of p-cumylphenyl acrylate (I, compound A2), 30 parts by weight of 2-hydroxy-3-phenoxy propyl acrylate (II)(refractive index: 1.526, compound B) and 1.5 parts by weight of 2-hydroxy-2-methylpropiophenone to 40 parts by weight of polyether urethane acrylate (refractive index: 1.460, oligomer) obtained by reaction of polypropylene glycol having an average molecular weight of about 3000 with toluene diisocyanate, hexamethylene diisocyanate and 2-hydroxyethyl acrylate. The glass plate carrying coated sheet was irradiated with light while moving toward lateral direction at a rate of 1.0 m/min from a 80 W/cm high pressure mercury lamp in the form of rod situated at a position 40 cm above the resulting resin composition in the form of sheet via shading plate provided with a slit so that the light hits the whole surface of the coated sheet vertically (see, FIG. 1), to obtain a light control film. Incidence angle dependency of its haze value was measured as shown in FIG. 2. From the resulting angle dependent haze curve (FIG. 3), the maximum haze value and haze value at an incidence angle of 60° as an index of degree of transparency were obtained and these results are shown in Table 1.

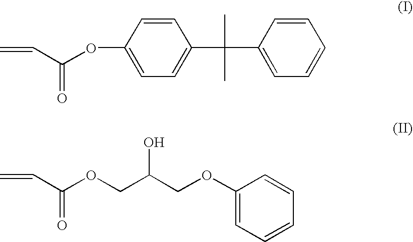

### Example 2

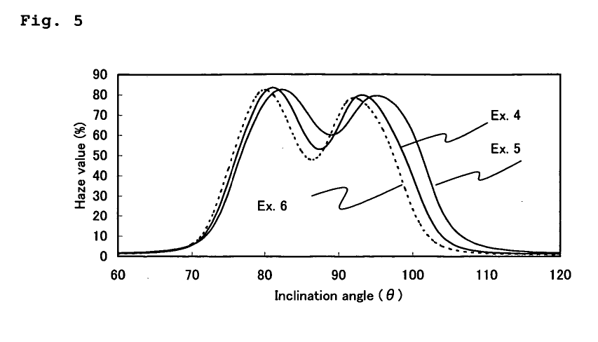

A light control film was obtained in the same operation as in Example 1 except that 30 parts by weight of tribromophenyl acrylate (VI) and 2 parts by weight of 2-t-butyl-6-(3′-t-butyl-5′-methyl-2′-hydroxybenzyl)-4-methylphenyl acrylate (VII, compound A1) were added instead of 30 parts by weight p-cumylphenyl acrylate (I, compound A2). Incidence angle dependency of its haze value was measured as shown in FIG. 2. From the resulting angle dependent haze curve (FIG. 4), the maximum haze value and haze value at an incidence angle of 120° as an index of degree of transparency were obtained and these results are shown in Table 1.

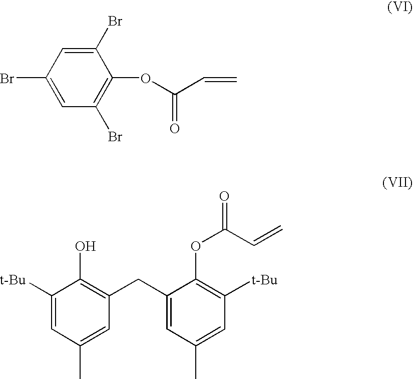

### Example 3

A light control film was obtained in the same operation as in Example 2 except that 2 parts by weight of 2-[1-(2-hydroxy-3,5-di-t-pentylphenyl)ethyl]-4,6-di-t-pentylphenyl acrylate (VIII, compound A1) was added instead of 2 parts by weight 2-t-butyl-6-(3′-t-butyl-5′-methyl-2′-hydroxybenzyl)-4-methylphenyl acrylate (VII, compound A1). The result is shown in Table 1.

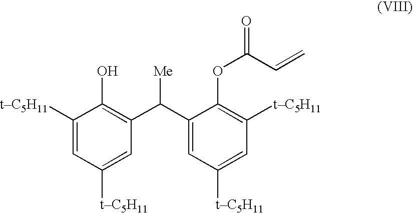

### Example 4

A light control film was obtained in the same operation as in Example 1 except that 30 parts by weight of 2-phenyl phenyl acrylate (IX, compound A2) was added instead of 30 parts by weight of p-cumylphenyl acrylate (I). Incidence angle dependency of its haze value was measured as shown in FIG. 2. From the resulting angle dependent haze curve (FIG. 5), the maximum haze value and haze value at an incidence angle of 120° as an index of degree of transparency were obtained and these results are shown in Table 1.

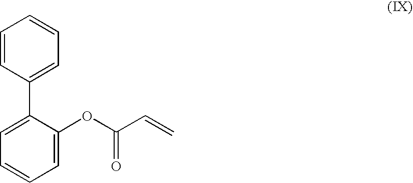

### Example 5

A light control film was obtained in the same operation as in Example 1 except that 30 parts by weight of 4-benzylphenyl acrylate (X, compound A2) was added instead of 30 parts by weight of p-cumylphenyl acrylate (I). Incidence angle dependency of its haze value was measured as shown in FIG. 2. From the resulting angle dependent haze curve (FIG. 5), the maximum haze value and haze value at an incidence angle of 120° as an index of degree of transparency were obtained and these results are shown in Table 1.

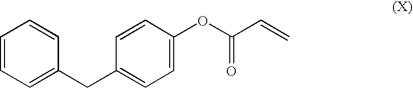

### Example 6

A light control film was obtained in the same operation as in Example 1 except that 30 parts by weight diphenyl methyl acrylate (XI, compound A2) was added instead of 30 parts by weight of p-cumylphenyl acrylate (I). Incidence angle dependency of its haze value was measured as shown in FIG. 2. From the resulting angle dependent haze curve (FIG. 5), the maximum haze value and haze value at an incidence angle of 120° as an index of degree of transparency were obtained and these results are shown in Table 1.

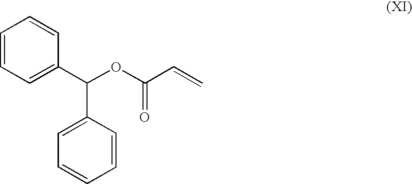

### Comparative Example 1

A light control film was obtained in the same operation as in Example 1 except that 60 parts by weight of 2-hydroxy-3-phenoxy acrylate (II, compound B) (refractive index: 1,526) was added instead of 30 parts by weight of p-cumylphenyl acrylate (I, compound A1) and 30 parts by weight of 2-hydroxy-3-phenoxy propyl acrylate (II, compound B). The result was shown in Table 1.

### Comparative Example 2

A light control film was obtained in the same operation as in Example 1 except that 30 parts by weight 2,4,6-tribromophenoxy ethyl acrylate (III, compound B)(refractive index: 1.567) was added instead of 30 parts by weight of p-cumylphenyl acrylate (I, compound A1). The result is shown in Table 1.

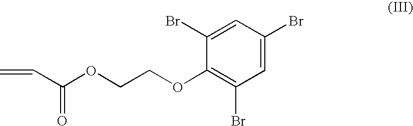

### Comparative Example 3

A light control film was obtained in the same operation as in Example 1 except that 30 parts by weight of bisphenol A epoxy-modified diacrylate (IV (mixture containing n=1 as main component), compound A′: compound having a plurality of aromatic rings and a plurality of carbon-carbon double bonds in the molecule) (refractive index: 1.545) was added instead of 30 parts by weight of p-cumylphenyl acrylate (I, compound A1). The result is shown in Table 1.

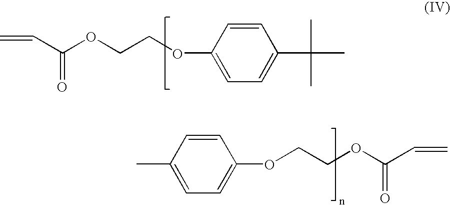

### Comparative Example 4

A light control film was obtained in the same operation as in Example 1 except that 30 parts by weight bisphenol diacrylate (V, compound A′) was added instead of 30 parts by weight of p-cumylphenyl acrylate (I, compound A1). The result is shown in Table 1.

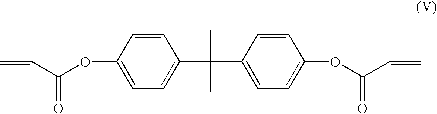

TABLE 1

| | | | | | | | Haze value (%) | |
|---|---|---|---|---|---|---|---|---|
| | | | | | | | Degree | |
| | Compound | | | | | | of | |
| | A, A′ | | Compound B | | Oligomer | | opacity | Degree of |
| | | Parts | | Parts | | Parts | (maximum | transparency |
| | | by | | by | | by | haze | (incidence |
| | Kind | weight | Kind | weight | Kind | weight | value) | angle 60°) |
| Example 1 | (I) | 30 | (II) | 30 | polyether | 40 | 80.6 | 3.4 |
| | | | | | urethane | | | |
| | | | | | acrylate | | | |
| Example 2 | (VII) | 2 | (II) | 30 | polyether | 40 | 95.3 | 3.0 |
| | | | (VI) | 30 | urethane | | | |
| | | | | | acrylate | | | |
| Example 3 | (VIII) | 2 | (II) | 30 | polyether | 40 | 93.7 | 3.3 |
| | | | (VI) | 30 | urethane | | | |
| | | | | | acrylate | | | |
| Example 4 | (IX) | 30 | (II) | 30 | polyether | 40 | 83.4 | 1.6 |
| | | | | | urethane | | | |
| | | | | | acrylate | | | |
| Example 5 | (X) | 30 | (II) | 30 | polyether | 40 | 82.4 | 1.7 |
| | | | | | urethane | | | |
| | | | | | acrylate | | | |
| Example 6 | (XI) | 30 | (II) | 30 | polyether | 40 | 82.4 | 1.3 |
| | | | | | urethane | | | |
| | | | | | acrylate | | | |
| Comparative | N/A | 0 | (II) | 60 | polyether | 40 | 67.6 | 1.3 |
| Example 1 | | | | | urethane | | | |
| | | | | | acrylate | | | |
| Comparative | N/A | 0 | (II) | 30 | polyether | 40 | 60.7 | 1.6 |
| Example 2 | | | (III) | 30 | urethane | | | |
| | | | | | acrylate | | | |
| Comparative | (IV) | 30 | (II) | 30 | polyether | 40 | 22.8 | 3.0 |
| Example 3 | | | | | urethane | | | |
| | | | | | acrylate | | | |
| Comparative | (V) | 30 | (II) | 30 | polyether | 40 | 80.5 | 11.7 |
| Example 4 | | | | | urethane | | | |
| | | | | | acrylate | | | |

The light control film in Example 1 showed a high haze value of 80% or more and a degree of transparency of 5% or less. On the other hand, when the compound B having one aromatic ring and one carbon-carbon double bond in the molecule is used (Comparative Examples 1 and 2) instead of the compound A, the degree of opacity decreased. When the compound A′ having a plurality of aromatic rings and a plurality of carbon-carbon double bonds in the molecule is used, the degree of opacity decreased (Comparative Example 3), or because of high degree of transparency, thus, a light control film excellent in contrast was not obtained (Comparative Example 4).

### INDUSTRIAL APPLICABILITY

The light control film of the present invention can be coated or pasted on a transparent base material such as a glass plate, other plastic sheets and the like. A laminate of the resulting transparent base material and a light control film of the present invention can be suitably used as an optical film for, e.g., building material windows, vehicle windows, mirrors, green house outer wall materials, flat panel displays, rear projection displays and the like.

1. A light control film obtained by irradiating a composition in the form of sheet comprising at least one compound having a plurality of aromatic rings and one polymerizable carbon-carbon double bond in the molecule with ultraviolet ray and hardening the composition.

2. The light control film according to claim 1, wherein at least one compound having a plurality of aromatic rings and one polymerizable carbon-carbon double bond in the molecule is a compound containing no aromatic hydroxyl group and the content of the compound based on 100 parts by weight of the composition in the form of sheet is 10 to 90 parts by weight.

3. The light control film according to claim 2, wherein the compound containing no aromatic hydroxyl group is at least one compound selected from the group consisting of 2-phenylphenyl acrylate, p-cumylphenoxy ethyl acrylate, 4-benzylphenyl acrylate and diphenyl methyl acrylate.

4. The light control film according to claim 1, wherein at least one compound having a plurality of aromatic rings and one polymerizable carbon-carbon double bond in the molecule is a compound containing an aromatic hydroxyl group and the content of the compound based on 100 parts by weight of the composition in the form of sheet is 0.1 to 30 parts by weight.

5. The light control film according to claim 4, wherein the compound containing an aromatic hydroxyl group is at least one compound selected from the group consisting of 2-t-butyl-6-(3′-t-butyl-5′-methyl-2′-hydroxybenzyl)-4-methylphenyl acrylate and 2-[1-(2-hydroxy-3,5-di-t-pentylphenyl)ethyl]-4,6-di-t-pentylphenyl acrylate.

6. The light control film according to claim 1, wherein the compound contained in the composition in the form of sheet includes at least two compounds of which homopolymers show a difference in refractive index of 0.01 or more.

7. The light control film according to claim 1, wherein the composition in the form of sheet is a composition comprising an oligomer having a refractive index of less than 1.51 as the compound having a polymerizable carbon-carbon double bond.
